(19) United States
(12) Patent Application Publication
(10) Pub. No.: US 2006/0135087 A1
(43) Pub. Date: Jun. 22, 2006

(54) Limited use telecommunications device

(76) Inventor: Robert Azzaro, Pacifica, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/021,257

(22) Filed: Dec. 21, 2004

(51) Int. Cl. H04B 1/38

(52) U.S. Cl. 455/90.3

(57) ABSTRACT

In accordance with the present invention there is provided a cellular phone adapted to be used by a young child. The phone only has three buttons for use by the child that are programmed by the child's parents. The buttons are programmed by first receiving a call on the phone from the phone number that is to be programmed. Next, the parent will assign the phone number to one of the call buttons on the phone. The phone number is assigned by either pressing the call button for a prescribed period of time, or by simultaneously pressing the call button with a programming button. The only buttons that are operable to the child will be the call buttons such that the phone will be easy to use.

### FIELD OF THE INVENTION

The present invention generally relates to telecommunications devices such as cellular phones and more particularly to a cellular phone adapted for use by young children.

### BACKGROUND OF THE INVENTION

Cellular telephones are frequently used as a means for family members to communicate with one another. Today, each family member may each have their own cellular phone in order to stay in touch. For example, parents often give their teenage sons and daughters cellular phones so that their children can contact the parents in case of emergency or to update parents on their plans.

Typically the cellular phone is complicated to use and has many buttons such that younger members of a family cannot use cellular phones. Younger children cannot use cellular phones because they are complicated. For example, the child may have difficulty turning the phone on or dialing numbers on the phone.

Emergency cellular phones can be simple to use, but do not offer the flexibility for use with a family. A typical emergency cellular phone allows a user to dial an emergency agency (i.e., police, fire department, hospital, etc . . . ) by pressing a single button on the phone. However, the phone cannot be used to dial numbers except the emergency numbers. This limits the use of the phone to the pre-programmed emergency services.

It would be advantageous to provide a young child a cellular phone for safety purposes. For example, while shopping, the child can use the phone to contact his or her parents if separated. Furthermore, if the child is away from his or her parents, it would be advantageous for the child to be able to contact his or her parents without having to know their phone number.

The present invention addresses the above-mentioned deficiencies in current cellular phones and emergency phones by providing an easy to use and program cellular telephone for small children to use. Specifically, the cellular phone of the present invention allows small children to contact their parents and/or emergency services without knowing their telephone numbers.

### SUMMARY OF THE INVENTION

In accordance with the present invention there is provided a cellular phone adapted to be used by a young child. The phone only has three buttons for use by the child that are programmed by the child's parents. The buttons are programmed by first receiving a call on the phone from the phone number that is to be programmed. Next, the parent will assign the phone number to one of the call buttons on the phone. The phone number is assigned by either pressing the call button for a prescribed period of time, or by simultaneously pressing the call button with a programming button. The only buttons that are operable to the child will be the call buttons such that the phone will be easy to use.

### BRIEF DESCRIPTION OF THE DRAWINGS

These, as well as other features of the present invention, will become more apparent upon reference to the drawings wherein:

FIG. 1 illustrates a cellular phone constructed in accordance with a preferred embodiment of the invention; and

FIG. 2 is a block diagram for the cellular phone shown in FIG. 1.

### DETAILED DESCRIPTION

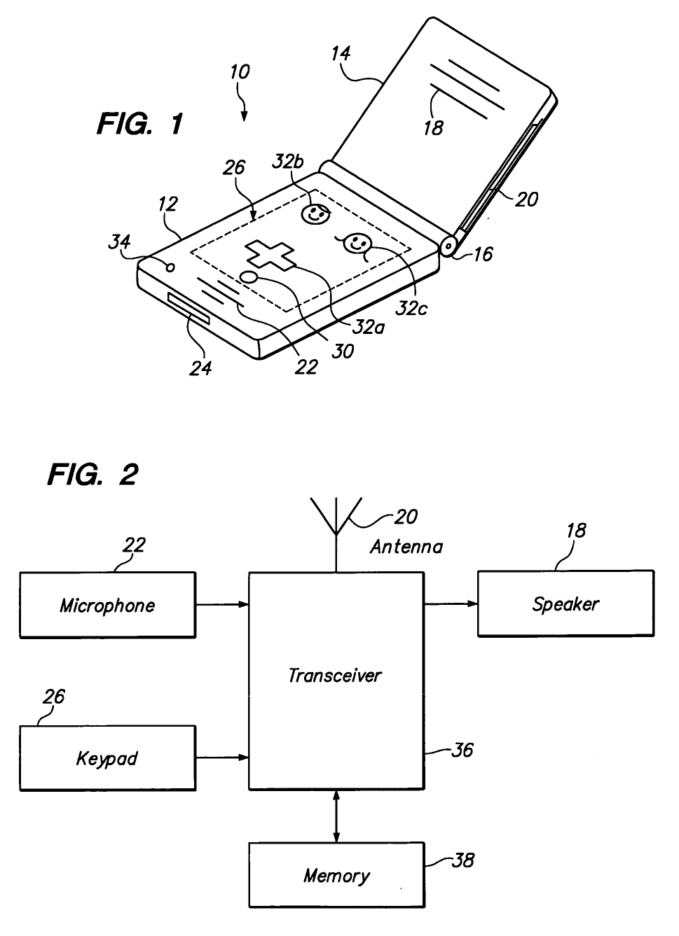

Referring now to the drawings wherein the showings are for purposes of illustrating preferred embodiments of the present invention only, and not for purposes of limiting the same, FIG. 1 illustrates a cellular phone 10 for use by a young child. The phone 10 is given to the child by his or her parents in order for the child to keep in touch with the parents. The cellular phone 10 has a lower portion 12 attached to an upper portion 14 by a hinge 16. In this sense, the cellular phone 10 is a “flip” type phone whereby the phone 10 can be answered by opening the upper portion 14. Furthermore, a call on the phone 10 can be stopped (i.e., hang-up) by closing the upper portion 14. The upper portion 14 acts as a cover over the lower portion 12 to prevent inadvertent selection of any of the buttons on the phone 10. It will be recognized by those of ordinary skill in the art that the “flip” type form factor for the phone 10 is only an example of one type of phone and that the phone 10 can be embodied by other form factors such as a traditional phone without an upper portion 14.

The upper portion 14 of the phone 10 has a speaker 18 that is used to listen to telephone conversations. The upper portion 10 also has an integrated antenna 20. Typically, the antenna 20 is not extendable in order to prevent the child from damaging the antenna.

The lower portion 12 of the phone 10 has a microphone 22 for receiving the voice of the user. Furthermore, the lower portion 12 has a charging receptacle or plug 24 for recharging an internal battery of the phone 10.

The phone 10 has a keypad 26 for dialing and programming numbers into the phone 10. The keypad 26 is kept simple for use by young children. In the example shown in FIG. 1, the keypad 26 has only four buttons that operate the phone 10. A recessed on/off/program button 30 is used to turn the phone off and on. The button 30 may be recessed such that a pen or pin is needed to push the button. This feature makes it difficult for a child to turn off the phone. In this respect, only the parent of the child has the ability to turn the phone on and off. Furthermore, the button 30 may be used to program and assign numbers to the other buttons of the keypad 26 as will be further explained.

The keypad 26 further includes three call buttons 32a, 32b, and 32c for dialing other phones. Each call button 32 is a picture of the person or entity that is to be called. For example, call button 32a is a picture of a cross indicating emergency services. Call button 32b is a picture of a man who may be a father of the child while call button 32c is a picture of a woman who may be the mother of the child. By pressing a call button 32, the phone 10 will dial the number assigned to that button. The emergency services button 32c can be deactivated to prevent inadvertent operation. In this respect, the emergency services call button 32c may be optional.

By only having a limited number of buttons on the keypad 26, the phone 10 can be easily used by children. The child only needs to associate the picture on the button 32 with the person or entity he or she wants to call. For example, if the child wants to call his father, he will press the call button 32b that is a picture of a man. This makes it easy for the child to use the phone 10. By not having any other buttons, the child cannot change the features and/or settings of the phone 10.

The buttons 32 are assigned to phone numbers by using the on/off/program button 30. Specifically, when a parent wants to assign a number to a button, the parent will call the phone 10 with the phone that is to be assigned to a button 32. Next, the call is answered with the phone 10. In order to assign the phone number to the assigned button 32, both the recessed programming button 30 and the call button 32 to be assigned the phone number are pressed simultaneously. By using the caller ID feature of the calling phone, the receiving phone 10 will have the number of the calling phone that is assigned to the selected button 32.

The number of the calling phone must be available via to the phone 10 through the caller ID feature. If the number of the calling phone is normally blocked, the caller must temporarily unblock the number before calling the child's phone 10. An indicator light 34 can illuminate to show the programming status of the phone 10 and whether the phone is turned on/off or charging.

It will be recognized by those of ordinary skill in the art that there are other ways of programming the phone 10. For example, the phone 10 may be programmed by simply depressing the desired button 32 for a prescribed period of time after receiving a call from that number. In this respect, the recessed button 30 would not be used.

Referring to FIG. 2, a block diagram of the phone 10 is illustrated. The phone 10 has microphone 22, keypad 26, antenna 20, and speaker 18 connected to a transceiver 36 which places and receives calls according to the cellular system of the phone 10. A memory 38 stores the numbers assigned to the buttons 32 of the keypad 26. The transceiver 36 may be an integrated circuit or formed from discrete components. In this respect, the transceiver 36 may include a processor or other component that is used to program and assign numbers to the buttons 32.

During operation, the user will use keypad 26 to operate the phone 10. Signals from the keypad 26 are received and processed by the transceiver 36. In this regard, the transceiver 36 can determine when the user is programming a button 32 as opposed to placing a call with a button 32. The microphone 22 is used to process the user's voice into electrical signals that are sent to the transceiver 36. The speaker 18 converts electrical signals from the transceiver 36 into audio signals. The antenna 20 is used for transmitting and receiving signals over the wireless network of the phone 10.

The phone 10 may also include a GPS unit for locating the phone and child. The GPS can report the location of the phone and hence the child if the child becomes lost. The cellular phone service provider, authorities or the child's parents can access the location information.

As described above, the phone 10 is ideally suited for young children because the child only has the option of sending calls to limited numbers. The phone 10 can be easily programmed by parents such that it is easy for them to change the pre-programmed numbers if needed.

It will be appreciated by those of ordinary skill in the art that the concepts and techniques described here can be embodied in various specific forms without departing from the essential characteristics thereof such as adapting the phone 10 to be used as a two-way radio instead of as a cellular telephone. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A cellular phone for a child, the phone comprising:
a keypad having a call button adapted to be used by the child, the call button being operative to place a call to a prescribed phone number, the call button being assigned to the prescribed number by receiving a call from a phone with that prescribed number and assigning the prescribed number to the button.

2. The phone of claim 1 wherein the keypad has three buttons adapted to be used by the child, each of the buttons being assigned a different prescribed number.

3. The phone of claim 2 wherein the each of the buttons corresponds to a character for easy identification by the child.

4. The phone of claim 3 wherein a first button is a character of a man, a second button is a character of a woman, and a third button is a character of a cross.

5. The phone of claim 1 wherein the keypad further comprises a programming button for assigning the prescribed number to the button.

6. The phone of claim 5 wherein the programming button and the call button are simultaneously selected in order to assign the prescribed number to the call button.

7. The phone of claim 1 wherein the phone with the prescribed number has a caller ID feature enabled.

8. The phone of claim 1 wherein the prescribed number is assigned to the call button by depressing the call button for a prescribed period of time after a call from the prescribed number has been received.

9. A method of programming a call button of a phone to dial a prescribed number, the method comprising the following steps:
dialing the phone with a second phone having the prescribed number and a caller ID function enabled;
selecting a call button of the phone to be assigned to the prescribed number; and
programming the prescribed number to the selected call button using the telephone number from the caller ID function.

10. The method of claim 9 wherein the number is programmed to the selected button by depressing the selected button for a prescribed period of time.

11. The method of claim 10 wherein the phone has a first, second and third call button and each of the buttons is programmed from a respective number called to the phone.

12. The method of claim 11 wherein the phone has a call programming button and the method further comprises the step of selecting the call programming button simultaneously with the call button in order to program the prescribed number to the call button.

13. A cellular phone adapted for use by children, the cellular phone comprising:
a transceiver for placing and receiving calls over a cellular phone network;
a microphone in electrical communication with the transceiver for converting audio signals to electrical signals;
a speaker in electrical communication with the transceiver for converting electrical signals into audio signals;
an antenna in electrical communication with the transceiver for transmitting and receiving signals over the cellular phone network;
a memory in electrical communication with the transceiver for storing telephone numbers; and
a keypad in electrical communication with the transceiver, the keypad having a call button programmed to a prescribed number by receiving a call from a phone with that prescribed number and assigning the prescribed number to the button.

14. The phone of claim 13 wherein the prescribed number is stored in the memory.

15. The phone of claim 13 wherein the keypad has three buttons and the buttons are programmed to a respective prescribed number by receiving a call from the respective phone with that prescribed number and assigning the prescribed number to the button.

16. The phone of claim 15 wherein each of the buttons is a character.
